(19) United States
(12) Patent Application Publication
(10) Pub. No.: US 2025/0276480 A1
(43) Pub. Date: Sep. 4, 2025

(54) TUBE PRODUCTION, PRE-INSULATED TUBULAR RODS

(71) Applicants: Olaf BASELAU, Biedenkopf (DE); Michael Eck, Gailingen (DE); Gerd Gosmann, Pfaffenhofen (DE); Uwe Grebe, Biedenkopf (DE); Sai Kumar Jetti, Gladenbach (DE); Alexander Schmidt, Lahntal (DE); Frank Wissler, Öhningen (DE)

(72) Inventors: Olaf BASELAU, Biedenkopf (DE); Michael Eck, Gailingen (DE); Gerd Gosmann, Pfaffenhofen (DE); Uwe Grebe, Biedenkopf (DE); Sai Kumar Jetti, Gladenbach (DE); Alexander Schmidt, Lahntal (DE); Frank Wissler, Öhningen (DE)

(21) Appl. No.: 19/052,967

(22) Filed: Feb. 13, 2025

(30) Foreign Application Priority Data
Mar. 1, 2024 (EP) 24160742.3

(51) Int. Cl. B29C 48/00; B29C 48/151; B29C 48/79; B29K 105/04; B29L 23/00; F16L 59/02; F16L 59/14

(52) U.S. Cl. CPC B29C 48/0021; B29C 48/0022; B29C 48/151; B29C 48/79; F16L 59/028; F16L 59/143; B29K 2105/04; B29K 2995/0015; B29L 2023/225

(57) ABSTRACT

A method and production plant for producing pre-insulated tubular rods, includes:
feeding an endless medium tube to a transport unit of a production plant,
transporting the endless medium tube in the axial direction,
applying a foamed insulating layer to the outer circumference of the endless medium tube during transport of the endless medium tube,
applying an outer layer to the outer circumference of the insulating layer,
dividing the pre-insulated endless tube into individual pre-insulated tubular rods,
wherein individual tubular medium rods are fed to the production plant and are connected to one another to form the endless medium tube.

### CROSS-REFERENCE TO RELATED APPLICATIONS

This application claims the benefit and priority of European Patent Application No. 24160742.3 filed Mar. 1, 2024. The entire disclosure of the above application is incorporated herein by reference.

### BACKGROUND OF THE INVENTION

### Technical Field

The invention relates to a method and to a production plant for producing pre-insulated tubular rods, comprising the following method steps:
feeding an endless medium tube to a transport unit of the production plant,
transporting the endless medium tube in the axial direction by means of the transport unit,
applying a foamed insulating layer to the outer circumference of the endless medium tube by means of an insulating station during transport of the endless medium tube,
applying an outer layer to the outer circumference of the insulating layer by means of a jacketing station, and dividing the pre-insulated endless tube into individual pre-insulated tubular rods by means of a dividing station.

Pre-insulated tubes are required in various technical sectors. They are used to transport hot and cold media in order to reduce heat exchange. The methods for producing them involve feeding an inner medium tube to a plant which applies the insulating layer and the surrounding jacketing layer. It is known from the prior art that the inner medium tube is fed to the plant as an endless medium tube, which is wound up to form a coil. After the application of the insulating layer and the jacketing layer, the endless tube is divided into easily handled tubular rods.

### Discussion

EP 1 371 469 A2 discloses a production method in which the inner tube is withdrawn from a storage drum and fed to the plant. The inner tube is surrounded concentrically by a film forming a slotted tube, which forms the outer tube. An expandable-foam plastic is introduced between the two tubes.

The disadvantage with such a method is that coils or tubes wound onto storage drums have to be produced exclusively for the production of pre-insulated tubes, as well as the handling of the coils. Moreover, precise alignment of the tubes is virtually impossible on account of the fact that the tubes are wound up into coils and are curved. Likewise, the tube cross section tends to deform into an oval shape on account of the curvature due to storage on the storage drums.

It is an aspect of the invention to propose a method and a production plant which improve the economy of production of pre-insulated tubular rods and to ensure consistently good quality of pre-insulated tubular rods.

### SUMMARY

This aspect is achieved in that the production plant has a tubular medium rod connecting station, and the latter connects together the individual tubular medium rods fed to the production plant to form an endless medium tube.

The method according to the preferred embodiment of the invention for producing pre-insulated tubular rods includes:
feeding an endless medium tube to a transport unit of a production plant,
transporting the endless medium tube in the axial direction, preferably continuously,
applying a foamed insulating layer to the outer circumference of the endless medium tube during transport of the endless medium tube,
applying an outer layer to the outer circumference of the insulating layer,
dividing the pre-insulated endless tube into individual pre-insulated tubular rods,
wherein individual tubular medium rods are fed to the production plant and are connected to one another to form an endless medium tube.

The connection of the individual tubular medium rods takes place before the feeding in of the transport unit in order to ensure that the endless medium tube formed is transported, preferably continuously and as a whole, through the production plant.

It is advantageous if the feeding of the production plant with the endless medium tube is accomplished by means of at least one transport unit that is preferably formed by a withdrawal unit that transports the endless medium tube continuously in the axial direction through the production plant.

Transport preferably takes place continuously through the entire production plant. It is advantageous if no stops are performed during method steps but all processes take place during transport.

It has proven to be a preferred embodiment if the outer surface of the medium tube is treated to improve adhesion of the insulating layer. The treatment preferably takes place during the transport of the endless medium tube.

The outer surface of the endless medium tube is preferably plasma-treated. As a result, the outer surface is activated, and the insulating layer has better adhesion.

It is advantageous if the individual tubular medium rods are fed in succession to a connecting station of the production plant by means of a feed station at the start of the production plant. As a feed station, a tubular rod magazine, a tubular rod loader or similar units can preferably be used. By means of the connecting station, the individual tubular medium rods are connected to form an endless medium tube, which is then transported through the production plant by means of the transport unit.

It has proven advantageous if the tubular medium rods fed in are joined together at their ends by means of the connecting station during the continuous transport. The tubular medium rods are thereby connected to one another by a materially integral connection.

The tubular medium rods fed in are preferably butt-welded during the continuous transport. This is preferably accomplished by means of heating-element butt welding or infrared butt welding. It is advantageous if the connecting station, which preferably has a welding machine, travels continuously along with the medium tube during the welding process and, once welding is complete, returns to its initial location again.

It has proven to be a preferred embodiment if the tubular medium rods fed in are connected by means of a tube connector. In this case, a nonpositive and positive connection is established between the tubular medium rod ends and the tube connector. The tube connector is preferably designed as an internal nipple.

The tube connector is preferably arranged in the interior or on the inner circumference of the two successive ends of the tubular medium rods, and forms a frictional engagement between the tube connector and each of the two ends of the tubular medium rods in order to ensure the transport in the axial direction of the endless medium tube formed by the inserted tube connector.

The foamed insulating layer, which is preferably formed from a PUR foam, is applied to the outer surface of the endless medium tube at the insulating station in the production plant. In this case, the endless medium tube is guided continuously centrally through a corrugator in a constant movement in the axial direction. By means of circumferential half shells that travel along synchronously and parallel to the endless medium tube over a defined length, this forms the foam mould that shapes the insulating foam. In general, corrugators are used for the production of corrugated tubes but they are also used to produce tubes with a smooth or level circumferential surface. The foamed insulating layer preferably has a level circumferential surface, although it is entirely conceivable to provide a corrugated external structure if required. The foam is preferably metered into the corrugator by means of a reaction casting machine via a mixing head directly in the inlet region of the endless medium tube. It is advantageous if a film is inserted into the corrugator for the purpose of mould parting, enabling the half shells to be removed easily from the insulating foam. The foam layer is transported onwards by the axial movement of the endless medium tube, the film and the half shells. As the corrugator progresses further, the foam expands and solidifies until it leaves the corrugator.

The outer layer is applied to the outer circumference of the insulating layer or cured foam. The outer layer preferably consists of a thermoplastic. This jacketing is preferably accomplished by means of a jacketing tube head. It is advantageous if, after the cooling of the outer layer, the pre-insulated endless tube passes through another transport unit, which is preferably designed as a withdrawal unit. Division into pre-insulated tubular rods then takes place.

It has proven advantageous if the division of the pre-insulated endless tube into individual pre-insulated tubular rods takes place at the connection point of the individual tubular medium rods. As a result, the endless tube is divided again at the points where it was connected, thus ensuring a flawless internal surface in the pre-insulated tubular rods.

It is advantageous if identification of the connection point is accomplished by way of section tracking or by detection. For this purpose, the production plant knows the section travelled and knows when the connection point of the individual tubular rods has reached the dividing station for division, or, for example, an indicator has been incorporated into the connection, e.g. a metal element which is detected when it has reached the dividing station.

The production plant according to the invention for producing pre-insulated tubes comprises a transport unit for feeding and transporting an endless medium tube in the axial direction, an insulating station for applying a foamed insulating layer to the outer circumference of the endless medium tube, a jacketing station for applying the outer layer to the outer circumference of the insulating layer, and a dividing station for dividing the pre-insulated endless tube into individual pre-insulated tubular rods, wherein the production plant has a tubular medium rod connecting station.

It is advantageous if the tubular medium rod connecting station is arranged at the start of the production plant. The connecting station preferably has a butt-welding machine, which moves axially and continuously with the tubular medium rods until welding has been completed, and it then moves back into its initial position.

At the medium tube connecting station, a tube connector is preferably arranged on the inner circumference in two successive tubular medium rod ends, and this connects the tubular medium rod ends to one another.

It is advantageous if the production plant has a feed station for feeding in the tubular medium rods. The feed station is preferably arranged at the start of the production plant. This is followed by the medium tube connecting station, which connects the individual tubular medium rods to one another to form an endless medium tube. Tubular rod magazines, tubular rod loaders or similar units have proven to be preferred feed stations.

As a preferred embodiment, the insulating station has a reaction casting machine and a corrugator. As explained above, the foam is applied to the outer circumference of the endless medium tube and cured by means of the reaction casting machine and the corrugator.

It is advantageous if the production plant has a treatment station for treating the outer circumference of the medium tube. The treatment station is preferably designed as a plasma treatment station.

All the embodiment possibilities can be freely combined with one another, and the features of the method can also automatically relate to the production plant and vice versa to avoid repetitions.

An exemplary embodiment of the invention is described with reference to the FIGURES, wherein the invention is not restricted only to the exemplary embodiment. In the drawing:

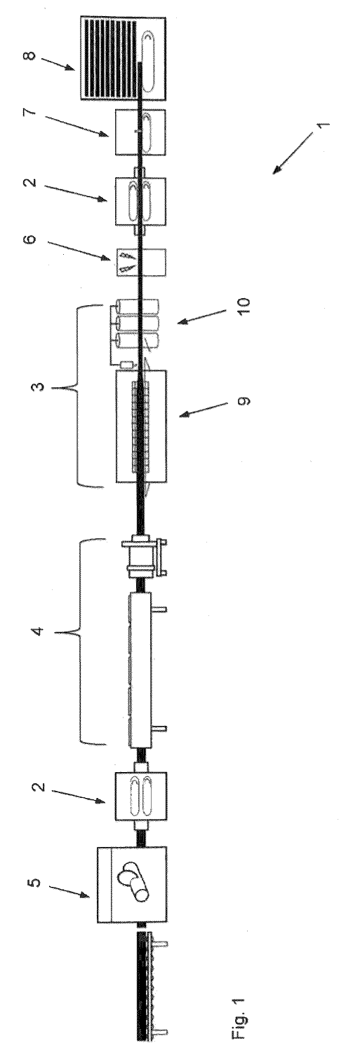

FIG. 1 shows a schematic view of a production plant according to the invention.

### DESCRIPTION OF THE PREFERRED EMBODIMENTS OF THE INVENTION

The image depicted in FIG. 1 shows a schematically illustrated production plant 1 according to the invention. The production plant comprises at least one transport unit 2 for feeding in and continuously transporting the endless medium tube and also the pre-insulated endless tube in the axial direction. Arranged after this in the transport direction, the production plant 1 has an insulating station 3 for applying a foamed insulating layer to the outer circumference of the endless medium tube. For jacketing the insulating layer, the production plant 1 has a jacketing station 4 after the insulating station. This forms the extruded outer layer around the outer circumference of the insulating layer. In order to cut the pre-insulated endless tube into pre-insulated tubular rods, a dividing station 6 is arranged at the end, the said station subdividing the pre-insulated endless tube into pre-insulated tubular rods. Wherein the subdivision takes place at the connection points of the tubular medium rods. This is preferably identified by the plant by means of section tracking or by detection by the insertion at the connection point of a detectableobject, e.g. a metal element.

Arranged at the start of the production plant 1 there is preferably a feed station 8, which feeds the tubular medium rods to the production plant 1 or the tubular medium rod connecting station 7. These are then connected to one another in the downstream tubular medium rod connecting station 7. This is accomplished, for example, by means of a butt-welding machine or by inserting a tube connector into the ends of the tubular medium rods and connecting the tube ends to the tube connector by frictional engagement. It has proven advantageous if the insulating station 3 has a reaction casting machine 10 and a corrugator 9 in order to apply the insulating layer and enable it to cure.

1. A method for producing pre-insulated tubular rods comprising:
feeding an endless medium tube to a transport unit of a production plant,
transporting the endless medium tube in the axial direction,
applying a foamed insulating layer to the outer circumference of the endless medium tube during transport of the endless medium tube,
applying an outer layer to the outer circumference of the insulating layer,
dividing the pre-insulated endless tube into individual pre-insulated tubular rods,
wherein individual tubular medium rods are fed to the production plant and are connected to one another to form the endless medium tube.

2. A method according to claim 1, wherein transport takes place continuously.

3. A method according to either of claim 1, wherein the outer surface of the endless medium tube or of the tubular medium rods is treated to improve adhesion of the insulating layer.

4. A method according to claim 1, wherein the outer surface of the endless medium tube is plasma-treated.

5. A method according to claim 1, wherein the individual tubular medium rods are fed in succession to a connecting station by means of a feed station at the start of the production plant.

6. A method according to claim 1, wherein the tubular medium rods fed in are joined together at their ends during the continuous transport.

7. A method according to claim 1, wherein the tubular medium rods fed in are butt-welded during the continuous transport.

8. A method according to claim 1, wherein the tubular medium rods fed in are connected by means of a tube connector.

9. A method according to claim 8, wherein the tube connector is arranged on the inner circumference of the two successive tubular medium rod ends, and a frictional engagement is formed between the tube connector and each of the two tubular medium rod ends in order to ensure the transport of the endless medium tube in the axial direction.

10. A method according to claim 1, wherein the division of the pre-insulated endless tube into individual pre-insulated tubular rods takes place at the position of the connection point of the individual tubular medium rods.

11. A method according to claim 10, wherein identification of the connection point is accomplished by way of section tracking or by detection.

12. A production plant for producing pre-insulated tubular rods according to claim 1, comprising a transport unit for feeding and transporting an endless medium tube in the axial direction, an insulating station for applying a foamed insulating layer to the outer circumference of the endless medium tube, a jacketing station for applying the outer layer to the outer circumference of the insulating layer, and a dividing station for dividing the pre-insulated endless tube into individual pre-insulated tubular rods, wherein the production plant has a tubular medium rod connecting station.

13. A production plant according to claim 12, wherein the production plant has a feed station for feeding in the tubular medium rods.

14. A production plant according to claim 12, wherein the insulating station has a reaction casting machine and a corrugator.

15. A production plant according to claim 12, wherein the production plant has a treatment station for treating the outer circumference of the medium tube.
